(19) United States
(12) Patent Application Publication
(10) Pub. No.: US 2022/0245839 A1
(43) Pub. Date: Aug. 4, 2022

(54) IMAGE REGISTRATION, FUSION AND SHIELDING DETECTION METHODS AND APPARATUSES, AND ELECTRONIC DEVICE

(71) Applicant: MEGVII (BEIJING) TECHNOLOGY CO., LTD., Beijing (CN)

(72) Inventor: Jiangyan XU, Beijing (CN)

(21) Appl. No.: 17/622,973

(22) PCT Filed: Jun. 16, 2020
(86) PCT No.: PCT/CN2020/096365

§ 371 Date: Dec. 27, 2021

(30) Foreign Application Priority Data
Jul. 5, 2019 (CN) 201910603555.8

(51) Int. Cl. G06T 7/33; G06T 7/11; G06T 7/00

(52) U.S. Cl. CPC G06T 7/33; G06T 2207/20221; G06T 7/0002; G06T 7/11

(57) ABSTRACT

A method for detection of image registration includes: after acquiring registration data between a first image and a second image, performing grid segmentation to the first image and the second image (100), wherein the registration data include at least a registration-point coordinate and a registration-point displacement; calculating a homography matrix of each of grids within the first image with a corresponding grid within the second image (200); calculating a difference between a registration-point displacement of each of registration points and a homography-matrix displacement of a grid where the registration point is located as a displacement difference (300); and according to the displacement difference, determining an erroneous registration point (400), wherein a registration point whose displacement difference from the grid where the registration point is located satisfies a predetermined condition is determined as an erroneous registration point.

The application claims the priority of the Chinese patent application filed on Jul. 5, 2019 before the Chinese Patent Office with the application number of 201910603555.8 and the title of “IMAGE REGISTRATION, FUSION AND SHIELDING DETECTION METHODS AND APPARATUSES, AND ELECTRONIC DEVICE”, which is incorporated herein in its entirety by reference.

### TECHNICAL FIELD

The present disclosure relates to the technical field of image processing, and particularly relates to a method and apparatus for image registration, fusion and blocking detection and an electronic device.

### BACKGROUND

Image registration refers to the process of matching and superposing two or more images that are acquired at different times, by different sensors (imaging devices) or under different conditions (weather, illuminance, photographing position and angle, and so on). It is indispensable in the scenes such as human-face recognition, identity authentication and smart city.

Currently, one of the most important research orientations is how to effectively perform image registration, to increase the accuracy of image registration. Based on the conventional image registration, by detecting the image that has been registered and determining the erroneous registration points therein, the accuracy of the registration can be further increased based on the original image registration.

However, currently there has not been an effective method for detecting image registration.

### SUMMARY

A problem solved by the present disclosure is how to detect the image that has been registered and determine the erroneous registration points therein.

In order to solve the above problems, firstly, the present disclosure provides a method for detection of image registration, wherein the method comprises:

after acquiring registration data between a first image and a second image, performing grid segmentation to the first image and the second image, wherein the registration data include at least a registration-point coordinate and a registration-point displacement;

calculating a homography matrix of each of grids within the first image with a corresponding grid within the second image;

according to the registration data and the homography matrix, calculating a difference between a registration-point displacement of each of registration points and a homography-matrix displacement of a grid where the registration point is located as a displacement difference; and

according to the displacement difference, determining an erroneous registration point, wherein a registration point whose displacement difference from the grid where the registration point is located satisfies a predetermined condition is determined as an erroneous registration point.

Secondly, the present disclosure provides a method for detecting a blocked region, wherein the method comprises:

determining erroneous registration points by using the method for detection of image registration stated above; and

according to a region formed by the erroneous registration points, determining the blocked region.

Thirdly, the present disclosure provides an apparatus for detection of image registration, wherein the apparatus comprises:

a grid-segmentation unit configured for, after acquiring registration data between a first image and a second image, performing grid segmentation to the first image and the second image, wherein the registration data include at least a registration-point coordinate and a registration-point displacement;

a matrix calculating unit configured for calculating a difference between a registration-point displacement of each of registration points and a homography-matrix displacement of a grid where the registration point is located as a displacement difference;

a displacement calculating unit configured for, according to the registration data and the homography matrix, calculating a difference between a registration-point displacement of each of registration points and a homography-matrix displacement of a grid where the registration point is located as a displacement difference; and

a registration determining unit configured for, according to the displacement difference, determining an erroneous registration point, wherein a registration point whose displacement difference from the grid where the registration point is located satisfies a predetermined condition is determined as an erroneous registration point.

Fourthly, the present disclosure provides an apparatus for detecting a blocked region, wherein the apparatus comprises:

the apparatus for detection of image registration configured for determining erroneous registration points; and

a region determining unit configured for, according to a region formed by the erroneous registration points, determining the blocked region.

Fifthly, the present disclosure provides an apparatus for fusing multi-photographed images, wherein the apparatus comprises:

a plurality-of-shot-images registering unit configured for acquiring a plurality of photographed images, and selecting two images from the plurality of photographed images as a first image and a second image for registration;

the apparatus for detecting a blocked region configured for determining the blocked region;

a reading-through unit configured for reading through the plurality of photographed images, and determining blocked regions in the plurality of photographed images; and

an image fusing unit configured for performing image fusion to remaining parts of the plurality of photographed images that exclude the blocked regions.

Finally, the present disclosure provides an electronic device, comprising a processor and a memory, wherein the memory stores a controlling program, and the controlling program, when executed by the processor, implements the method for detection of image registration stated above, or implements the method for detecting a blocked region stated above, or implements the method for fusing multi-photographed images stated above.

In addition, the present disclosure provides a computer-readable storage medium, storing an instruction, wherein the instruction, when loaded and executed by a processor, implements the method for detection of image registration stated above, or implements the method for detecting a blocked region stated above, or implements the method for fusing multi-photographed images stated above.

The above description is merely a summary of the technical solutions of the present disclosure. In order to more clearly know the elements of the present disclosure to enable the implementation according to the contents of the description, and in order to make the above and other purposes, features and advantages of the present disclosure more apparent and understandable, the particular embodiments of the present disclosure are provided below.

### BRIEF DESCRIPTION OF THE DRAWINGS

In order to more clearly illustrate the technical solutions of the embodiments of the present disclosure or the prior art, the figures that are required to describe the embodiments or the prior art will be briefly introduced below. Apparently, the figures that are described below are embodiments of the present disclosure, and a person skilled in the art can obtain other figures according to these figures without paying creative work.

FIG. 1A is a view photographed on the left in the principle diagram according to an embodiment of the present disclosure;

FIG. 1B is a view photographed on the right in the principle diagram according to an embodiment of the present disclosure;

FIG. 2 is a flow chart of the method for detection of image registration according to an embodiment of the present disclosure;

FIG. 3 is a flow chart of the step 300 of the method for detection of image registration according to an embodiment of the present disclosure;

FIG. 4 is an example view of the image to be registered according to an embodiment of the present disclosure;

FIG. 5 is an example view of the reference image according to an embodiment of the present disclosure;

FIG. 6 is an example view of the division of the image to be registered into overlapping grids according to an embodiment of the present disclosure;

FIG. 7 is a flow chart of the step 400 of the method for detection of image registration according to an embodiment of the present disclosure;

FIG. 8 is a flow chart of the step 200 of the method for detection of image registration according to an embodiment of the present disclosure;

FIG. 9 is a flow chart of the step 220 of the method for detection of image registration according to an embodiment of the present disclosure;

FIG. 10 is a flow chart of the method for detecting a blocked region according to an embodiment of the present disclosure;

FIG. 11 is an example view of the reference image after dense registration according to an embodiment of the present disclosure;

FIG. 12 is an example view of the blocked region of the reference image according to an embodiment of the present disclosure;

FIG. 13 is a flow chart of the method for fusing multi-photographed images according to an embodiment of the present disclosure;

FIG. 14 is a structural block diagram of the apparatus for detection of image registration according to an embodiment of the present disclosure;

FIG. 15 is a structural block diagram of the apparatus for detecting a blocked region according to an embodiment of the present disclosure;

FIG. 16 is a structural block diagram of the apparatus for fusing multi-photographed images according to an embodiment of the present disclosure;

FIG. 17 is a structural block diagram of the electronic device according to an embodiment of the present disclosure; and

FIG. 18 is a block diagram of another electronic device according to an embodiment of the present disclosure.

### DESCRIPTION OF THE REFERENCE NUMBERS

2-grid-segmentation unit, 3-matrix calculating unit, 4-displacement calculating unit, 5-registration determining unit, 6-region determining unit, 7-plurality-of-shot-images registering unit, 8-reading-through unit, 9-image fusing unit, 800-electronic device, 802-processing component, 804-memory, 806-power component, 808-multimedia component, 810-audio component, 812-input/output (I/O) interface, 814-sensor component, and 816-communication component.

### DETAILED DESCRIPTION

In order to make the above objects, features and advantages of the present disclosure more apparent and understood, the particular embodiments of the present disclosure will be described in detail below with reference to the drawings.

Apparently, the described embodiments are some of the embodiments of the present disclosure, rather than all of the embodiments. All of the other embodiments that a person skilled in the art obtains on the basis of the embodiments of the present disclosure without paying creative work fall within the protection scope of the present disclosure.

In order to facilitate the comprehension, in the present disclosure, the technical problems thereof are required to be stated in detail.

In the conventional image processing, frequently, double-photographed or multi-photographed images are required to be fused, to reach a better effect of photographing. Because the visions of the double-photographed or multi-photographed images are not consistent, the double-photographed or multi-photographed images have parallax. Such a parallax results in that the double-photographed or multi-photographed images have a blocked region, and, in the registration, because the points in the blocked region do not have corresponding points that can be registered within the other image, registration errors appear, which in turn results in that the image obtained after the fusion has artifact, color cast and so on.

In order to facilitate the comprehension, the technical principle of the technical solutions will be described here.

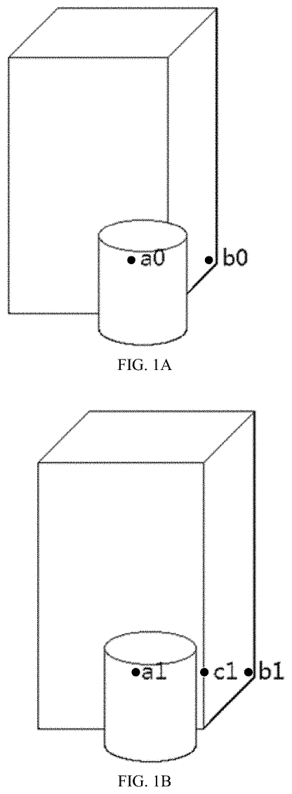

As shown in FIGS. 1A and 1B, FIGS. 1A and 1B are two images that are acquired in the mode of double photographing (and may also be acquired by photographing by using one camera at different directions). Because the photographing cameras have a position difference therebetween, the images have parallax. Assuming that the two cameras are arranged horizontally, and in FIGS. 1A and 1B the cylinder is in front of the cuboid, then the left-photographed view obtained by the left camera and the right-photographed view obtained by the right camera are shown in FIG. 1A and FIG. 1B respectively.

In FIGS. 1A and 1B, in the left-photographed view, more of the left area of the cuboid behind the cylinder can be seen, while some of the area of the right of the cuboid is blocked by the cylinder in front. In the same manner, in the right-photographed view, some of the area of the left of the cuboid is blocked by the cylinder, while more right area can be seen.

In order to perform the fusion between the double-photographed images, one of the photographed views may be selected as a reference view. The fusion will be performed below with the left view as the reference view. Firstly, it is required to register all of the points of the right view to the left view, thereby obtaining the registration points of the two images. Because of the parallax, the parallax of the object further from the cameras on the left and right photographed views is relatively small, while the parallax of the object closer to the cameras on the left and right photographed views is relatively large. Therefore, the registration points have a discontinuity at the parallax region. According to such a principle, the blocked region in the two images can be detected by using the discontinuity between the different parallaxes.

As shown in FIGS. 1A and 1B, it is assumed that the registration points a0 and a1 have already been registered, and b0 and b1 have already been registered. However, regarding the point c1 of the blocked region of the right-photographed view, in the left view its true registration point cannot be found, and such a point can merely find an erroneous registration position according to the registration rule, wherein the registration point is an erroneous registration point and a blocked point.

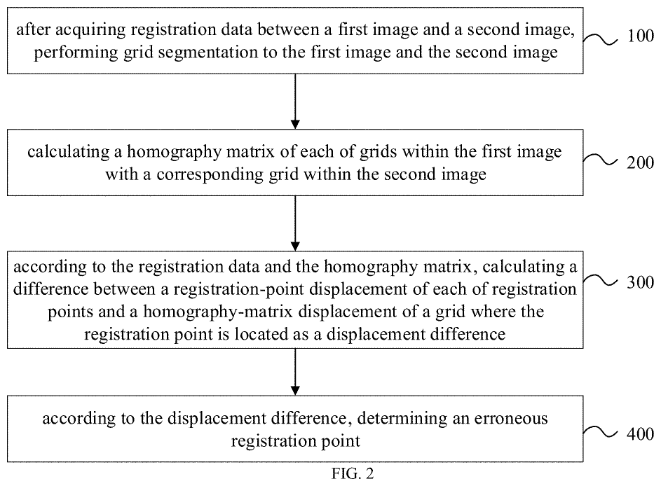

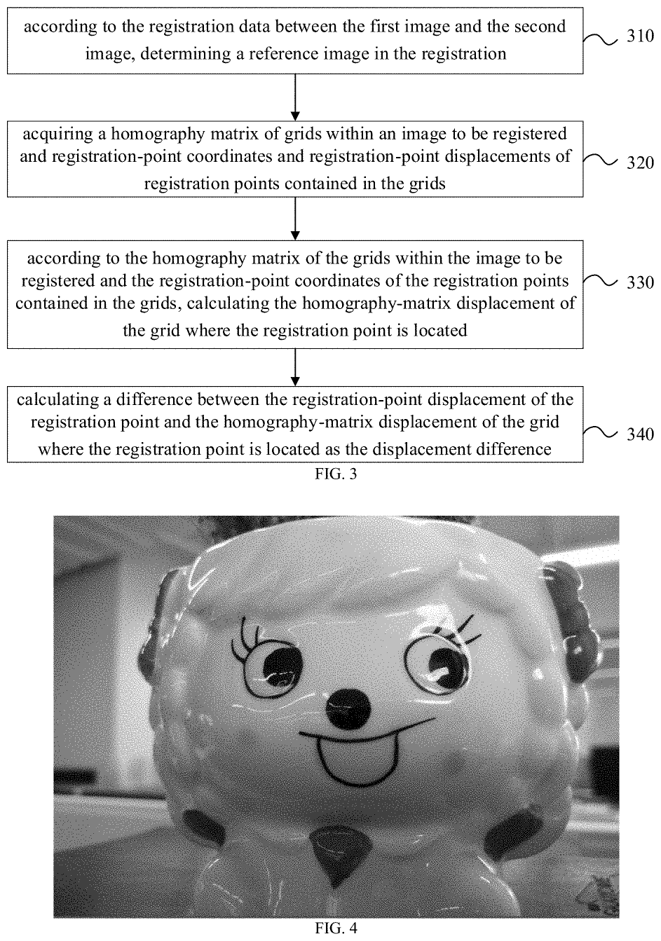

An embodiment of the present disclosure provides a method for detection of image registration, wherein the method may be implemented by an apparatus for detection of image registration, and the apparatus for detection of image registration may be integrated into an electronic device such as a mobile phone. As shown in FIG. 2, FIG. 2 is a flow chart of the method for detection of image registration according to an embodiment of the present disclosure. The method for detection of image registration comprises:

Step 100: after acquiring registration data between a first image and a second image, performing grid segmentation to the first image and the second image, wherein the registration data include at least a registration-point coordinate and a registration-point displacement.

The first image and the second image may be images of an object, and may also be images of a human being. In this step, the acquiring of the registration data between the first image and the second image may comprise acquiring the registration data from the registration process or the registration result of the first image and the second image that have already been registered. The first image and the second image may be registered directly, thereby obtaining the registration data therebetween.

The first image and the second image may be registered by relative registration; in other words, the first image and the second image are individually the image to be registered and the reference image. In such a case, the registration-point coordinates of the image to be registered and the registration-point displacements of the registration from the image to be registered to the reference image in the registration process may be directly read, wherein the registration-point coordinates and the registration-point displacements correspond, and wherein the registration-point displacements of the registration-point coordinates of the image to be registered and the corresponding registration-point coordinates of the reference image (a registration-point displacement of the registration from the image to be registered to the reference image and a registration-point displacement of the registration from the reference image to the image to be registered are vectors of opposite directions) are of a correspondence relation, and, when two of the data are known, the third datum can be calculated out by using the correspondence relation thereof. Therefore, the registration-point coordinates of the image to be registered and the registration-point displacements of the registration from the image to be registered to the reference image in the registration process may be directly read; or the registration-point coordinates of the reference image and the registration-point displacements of the registration from the image to be registered to the reference image (or the registration-point displacements of the registration from the reference image to the image to be registered) in the registration process may be directly read, and the registration-point coordinates of the image to be registered may be calculated out by using the correspondence relation; or the registration-point coordinates of the reference image and the registration-point coordinates of the image to be registered in the registration process may be directly read, and the registration-point displacements of the registration from the image to be registered to the reference image may be calculated out by using the correspondence relation, which are feasible equivalent solutions.

The first image and the second image may also be registered by absolute registration; in other words, both of the first image and the second image are an image to be registered. In such a case, the registration-point coordinates of the two images to be registered and the registration-point displacements of the registration from the image to be registered to a control grid (the control grid is defined) in the registration process may be directly read, and then the registration-point coordinates and the registration-point displacements of the registration from the first image to the second image or from the second image to the first image may be calculated out according to the registration-point coordinates and the registration-point displacements.

The above contents will be illustrated with examples. As shown in FIG. 4, FIG. 4 is an example view of an image to be registered. As shown in FIG. 5, FIG. 5 is an example view of an reference image. FIG. 4 is the image photographed when the camera is located slightly on the left of the doll, and FIG. 5 is the image photographed when the camera is located slightly on the right of the doll.

The contents of most of the areas of the images in FIGS. 4 and 5 can correspond, and merely part of the areas are blocked due to the difference in the angles of photographing. For example, part of the area of the position of the left ear of the doll in FIG. 4 does not have a corresponding position in FIG. 5, or, in other words, is blocked.

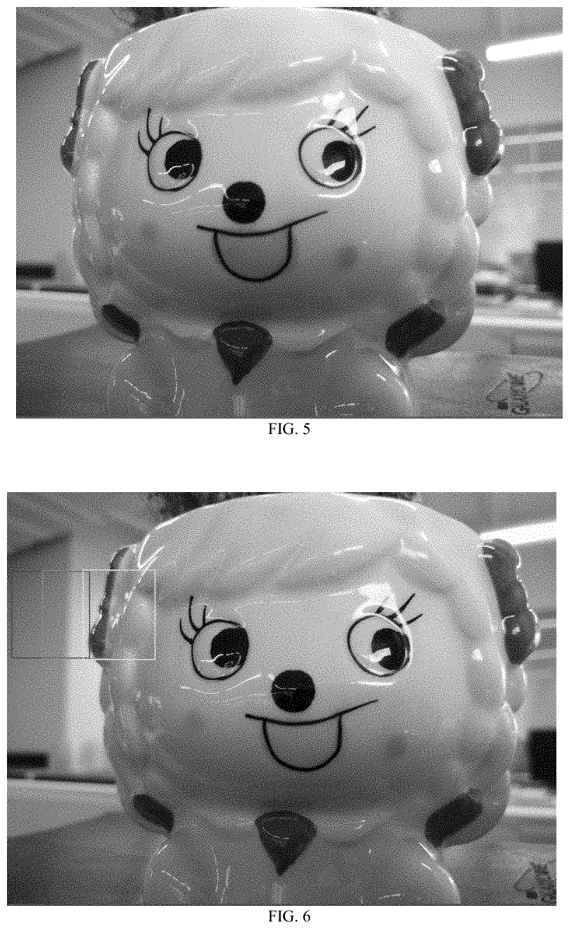

In the example, as shown in FIG. 6, its top-left corner is the schematic diagram of the division of overlapping grids. It can be seen from the figure that the overlapping grids refer to the overlapping parts between the neighboring grids.

The first image and the second image may be the same or similar scene pictures that are photographed by the camera in a collecting device at different angles, may also be the same or similar scene pictures that are photographed by cameras at different positions of an entire electronic device at the same moment, and may also be picture information that is inputted from a data input interface.

The first image and the second image may be two photographed pictures, and may also be any two of a plurality of photographed pictures.

Grid segmentation is performed to the first image and the second image, wherein the size of the grids may be determined according to actual situations. In the segmentation, firstly the grids may be located according to the registration points or the vertexes in the first image and the second image or by another means, thereby establishing the correspondence relation between the grids in the first image and the grids in the second image. Other manners may also be used to enable the registration points in the grids with the correspondence relation to have a high correspondence, to facilitate the detection on the accuracy of the registration points.

In order to facilitate the description on the particular embodiments of the present disclosure, the following contents illustrate by taking the case as an example in which the first image is the image to be registered and the second image is the reference image. Based on the illustration, a person skilled in the art can comprehend, by simple variation, the process of checking the image registration in which the second image is the image to be registered and the first image is the reference image, or in which there are a plurality of images.

Step 200: calculating a homography matrix of each of grids within the first image with a corresponding grid within the second image.

In this step, one of the grids of the first image and one of the grids of the second image that have the correspondence relation have a homography matrix therebetween. Because of the problem of the noise of the corresponding registration-point coordinates, the homography matrix has errors. A plurality of points may be provided to form an equation set of the homography matrix, and an optimum homography matrix may be obtained by calculating the optimal solution. In the calculation of the optimal solution, the optimal solution may be optimized by using a straight-line linear solution, singular value decomposition, Levenberg-Marquarat (LM) algorithm, and so on.

Step 300: according to the registration data and the homography matrix, calculating a difference between a registration-point displacement of each of registration points and a homography-matrix displacement of a grid where the registration point is located as a displacement difference.

The image to be registered has a plurality of registration points, those registration points have a one-to-one correspondence relation with the registration points of the reference image (when they have already been registered), and the displacement between two registration points that have the one-to-one correspondence relation refers to the registration-point displacement between the registration points.

The image to be registered has grids, one grid has a plurality of registration points therein, the grid has a corresponding grid in the reference image, and the two corresponding grids have a homography matrix therebetween. A registration point of the image to be registered, by the transformation by the homography matrix, has a corresponding third registration point in the reference image (the third registration point is determined by the coordinate of the registration point in the image to be registered and the homography matrix, and in an ideal condition, the third registration point and the corresponding registration point in the reference image coincide), and the displacement between the second registration point and the third registration point refers to a homography-matrix displacement.

The difference between the registration-point displacement of the registration point and the homography-matrix displacement of the grid where the registration point is located refers to the displacement difference of each of the registration points that is required to be calculated in this step.

Step 400: according to the displacement difference, determining an erroneous registration point, wherein a registration point whose displacement difference from the grid where the registration point is located satisfies a predetermined condition is determined as an erroneous registration point.

If the registration of the registration points is correct, the displacement difference between each of the registration points and the grid where it is located is small and does not satisfy a predetermined condition (except for errors and noise interference, the displacement difference is zero). If the registration of the registration points is erroneous, the displacement difference between each of the registration points and the grid where it is located is large and satisfies the predetermined condition.

Accordingly, in the step 100 to the step 400, by detecting the registration points of the image that has been registered, the erroneous registration points therein can be determined, which can, based on the original image registration, further increase the accuracy of the registration.

Optionally, in the step 100, the grid segmentation performed to the first image and the second image is overlapping-grid segmentation. Regarding the registration points in the overlapping grids, the same registration point may be distributed into two or more grids, and accordingly the displacement differences of the same registration point in the plurality of grids may be individually calculated. Accordingly, two or more displacement differences can be calculated out, and, by comprehensive determination of the two or more displacement differences, it can be determined whether the registration of the registration point is correct or erroneous. Such a determination mode can reduce or even overcome the problem of inaccurate determination on whether the registration of the registration points is correct or not caused by noise or errors, and further increase the accuracy of the determination on the registration of the registration points.

Optionally, in the overlapping-grid segmentation performed to the first image and the second image, an overlapping area between neighboring grids in the first image and the second image is at least ½ of an area of a single grid. That can ensure that, except the registration points at very little edge positions, the other registration points are distributed into at least two grids, which can result in that, except the registration points at the very little edge positions, all of the other registration points can be determined comprehensively according to the displacement differences of the plurality of grids, so as to increase the accuracy of the determination on the registration of the registration points.

Optionally, in the step 100 of acquiring the registration data between the first image and the second image, and performing grid segmentation to the first image and the second image, the registration between the first image and the second image is dense registration.

Dense registration is an image registration method that performs point-to-point matching to the images, in which the offsets of all of the points in the images are calculated, thereby forming a dense optical flow field. By using the dense optical flow field, image registration of the pixel level can be performed, and therefore the effect of the registration thereof is better and more accurate.

Accordingly, by using the dense registration, the first image and the second image can be registered more accurately, thereby increasing the accuracy of the registration.

As shown in FIG. 6, FIG. 6 is an example view of the division of the image to be registered into overlapping grids according to an embodiment of the present disclosure. The step 300 of, according to the registration data and the homography matrix, calculating the difference between the registration-point displacement of each of the registration points and the homography-matrix displacement of the grid where the registration point is located as the displacement difference comprises:

Step 310: according to the registration data between the first image and the second image, determining a reference image in the registration.

According to the above example, the second image is the reference image.

Step 320: acquiring a homography matrix of grids within an image to be registered and registration-point coordinates and registration-point displacements of registration points contained in the grids, wherein the image to be registered refers to other image than the reference image from the first image and the second image.

According to the above example, the first image is the image to be registered.

Step 330: according to the homography matrix of the grids within the image to be registered and the registration-point coordinates of the registration points contained in the grids, calculating the homography-matrix displacement of the grid where the registration point is located.

Step 340: calculating a difference between the registration-point displacement of the registration point and the homography-matrix displacement of the grid where the registration point is located as the displacement difference.

In order to facilitate the description on the registration points of the reference image and the image to be registered and the corresponding registration points in the homography matrix, a registration point of the image to be registered is referred to as a first registration point, a registration point of the reference image that has been registered with the first registration point is referred to as a second registration point, and a corresponding registration point that is calculated out from the first registration point and the homography matrix is referred to as a third registration point.

Accordingly, in the step 330 and the step 340, the registration-point displacement between the registration points is the displacements between the first registration point and the second registration point, the homography-matrix displacement between the registration point and the grid where it is located is the displacement between the first registration point and the third registration point, and the difference between the registration-point displacement of the registration point and the homography-matrix displacement of the grid where it is located is the displacement difference between the above two displacements.

The particular calculating process of the displacement difference between the registration point and the grid where it is located may comprise:

acquiring directly the registration displacement of the first registration point, or firstly acquiring the coordinate of the first registration point, then acquiring the coordinate of the second registration point, and calculating out the registration displacement of the first registration point; by using the coordinate of the first registration point and the homography matrix, calculating out the coordinate of the third registration point, and in turn calculating out the homography-matrix displacement of the first registration point; and by using the registration displacement of the first registration point and the homography-matrix displacement, calculating out the displacement difference.

In addition, based on the steps 330 and 340, an improved particular calculating process of the displacement difference between the registration point and the grid where it is located may also be proposed, and comprises:

acquiring directly the coordinate of the second registration point, or firstly acquiring the coordinate of the first registration point and the registration displacement of the first registration point, and then calculating out the coordinate of the second registration point; by using the coordinate of the first registration point and the homography matrix, calculating out the coordinate of the third registration point; and by using the coordinate of the second registration point and the coordinate of the third registration point, calculating out the displacement difference, wherein the displacement difference refers to the displacement between the coordinate of the second registration point and the coordinate of the third registration point.

Limited transformation may also be performed to the above two particular calculating processes by using the correspondence relation between the first registration point, the second registration point and the third registration point, thereby obtaining a new particular calculating process, and the process obtained after the transformation still falls within the protection scope of the present disclosure.

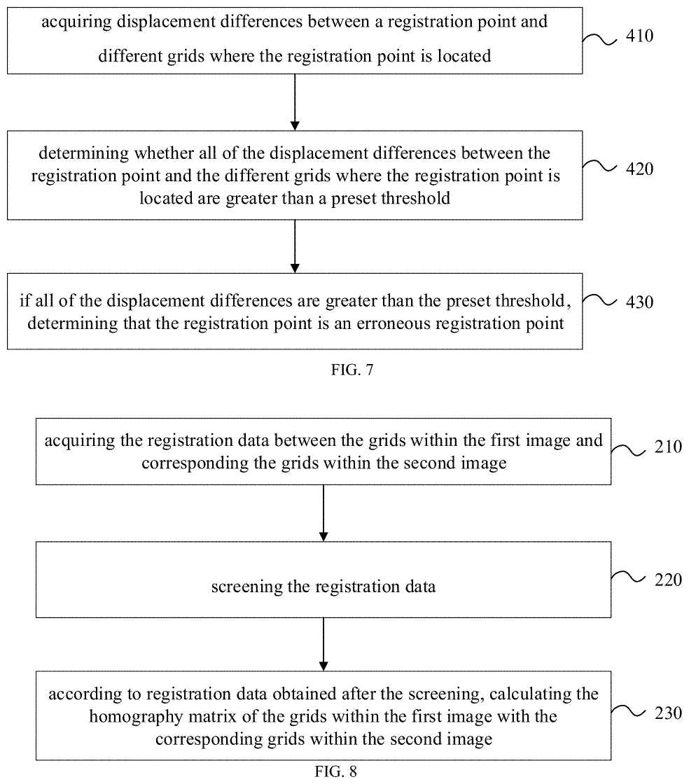

As shown in FIG. 7, FIG. 7 is a flow chart of the step 400 of the method for detection of image registration according to an embodiment of the present disclosure. The step 400 of, according to the displacement difference, determining the erroneous registration point comprises:

Step 410: acquiring displacement differences between a same registration point and different grids where the registration point is located, wherein the same registration point has at least two grids where the registration point is located.

A registration point is contained by a grid in an image (the registration point is located within the grid in the image), and the grid is the grid where the registration point is located.

When overlapping-grid segmentation is performed to the first image and the second image, then after the segmentation two neighboring grids in the same image have an overlapping part therebetween, and the registration points located within the overlapping part have two neighboring grids.

Similarly, the registration points may also have three grids or more grids.

Accordingly, the grids where the registration point is located are not merely one, and therefore the corresponding displacement differences are not merely one. In this step, the plurality of displacement differences of the plurality of grids where the registration point is located are acquired.

Step 420: determining whether all of the displacement differences between the registration point and the different grids where the registration point is located are greater than a preset threshold.

The preset threshold is the boundary whether the displacement differences between the registration point and the grids where the registration point is located are small or large (satisfying or not satisfying the predetermined condition), and distinguishes the small (not satisfying the predetermined condition) displacement differences and the large (satisfying the predetermined condition) displacement differences, thereby determining whether the registration is correct.

The preset threshold may be determined according to actual situations. For example, it may be determined by counting up the displacement differences that have already been calculated out between the registration point and a plurality of grids where the registration point is located, thereby finding out the boundary between the small and the large displacement differences, and selecting a boundary in the middle as the preset threshold. The preset threshold may also be acquired in other manners.

Step 430: if all of the displacement differences are greater than the preset threshold, determining that the registration point is an erroneous registration point.

In the process of the calculation of the homography matrix of two grids, the homography matrixes that are calculated out might be different because of the difference in the selected registration points. If the selected registration point is an erroneous registration point, that results in that the homography matrix that is calculated out has a large difference from the actual homography matrix, and the displacement difference that is calculated out accordingly is obviously larger (than a registration point correctly registered). Therefore, it cannot be directly determined that the registration point is an erroneous registration point only because the displacement difference of the registration point is greater than the preset threshold.

However, although the above-described registration point (the registration point correctly registered) might have a larger displacement difference for a single grid where it is located, the possibility that the displacement differences of the other grids where the registration point is located are also larger is very small. Therefore, a registration point all of whose displacement differences of the grids where it is located are greater than the preset threshold is determined as an erroneous registration point.

That can further increase the accuracy of the determination, and reduce the probability of determining a correct registration point to be an erroneous registration point.

As shown in FIG. 8, FIG. 8 is a flow chart of the step 200 of the method for detection of image registration according to an embodiment of the present disclosure. The step 200 of calculating the homography matrix of each of the grids within the first image with the corresponding grid within the second image comprises:

Step 210: acquiring the registration data between the grids within the first image and the corresponding grids within the second image.

The registration data in this step include at least the registration-point coordinate and the registration-point displacement.

Step 220: screening the registration data.

Because of the existence of the registration points erroneously registered, the first registration points within the grid of the first image and the second registration points within the corresponding grid of the second image do not correspond one to one. In other words, the second registration point corresponding to a first registration point within the grid of the first image might not be within the corresponding grid of the second image, or the first registration point corresponding to a second registration point within the grid of the second image might not be within the corresponding grid of the first image.

In order to facilitate the description, the grid of the first image is referred to as a first grid, the grid within the second image corresponding to the first grid is referred to as a second grid, the registration points within the first image are first registration points, and the registration points within the second image corresponding to the first registration points are second registration points. The registration data are screened. In other words, if the second registration point corresponding to a first registration point within the first grid is not within the second grid, then the first registration point is screened out, and the first registration points that have the corresponding second registration points within the second grid are maintained. Subsequently, on the basis of that, if the first registration point corresponding to a second registration point within the second grid is not within the first grid, then the second registration point is screened out, and the second registration points that have the corresponding first registration points within the first grid are maintained. Accordingly, after the two times of screening, the maintained first registration points within the first grid and the maintained second registration points within the second grid correspond to each other (all of the first registration points without the second registration points and all of the second registration points without the first registration points have already been screened out).

Step 230: according to registration data obtained after the screening, calculating the homography matrix of the grids within the first image with the corresponding grids within the second image.

Accordingly, the possibility that the first registration points and the corresponding second registration points in the registration data that have been screened are accurately registered is higher, whereby the accuracy of the homography matrix that is calculated out is also higher.

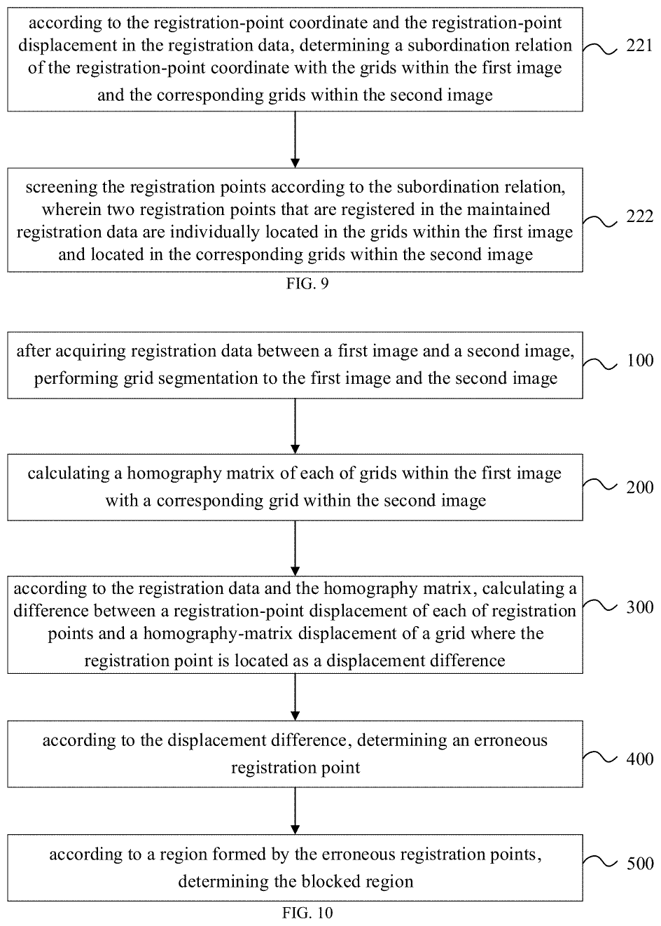

As shown in FIG. 9, FIG. 9 is a flow chart of the step 220 of the method for detection of image registration according to an embodiment of the present disclosure. The step 220 of screening the registration data comprises:

Step 221: according to the registration-point coordinate and the registration-point displacement in the registration data, determining a subordination relation of the registration-point coordinate with the grids within the first image and the corresponding grids within the second image, wherein the subordination relation refers to whether the registration point is located in the grids within the first image or located in the grids within the second image.

Step 222: screening the registration points according to the subordination relation, wherein two registration points that are registered in the maintained registration data are individually located in the grids within the first image and located in the corresponding grids within the second image.

Accordingly, by screening the registration points, the accuracy of the homography matrix that is calculated out can be further increased.

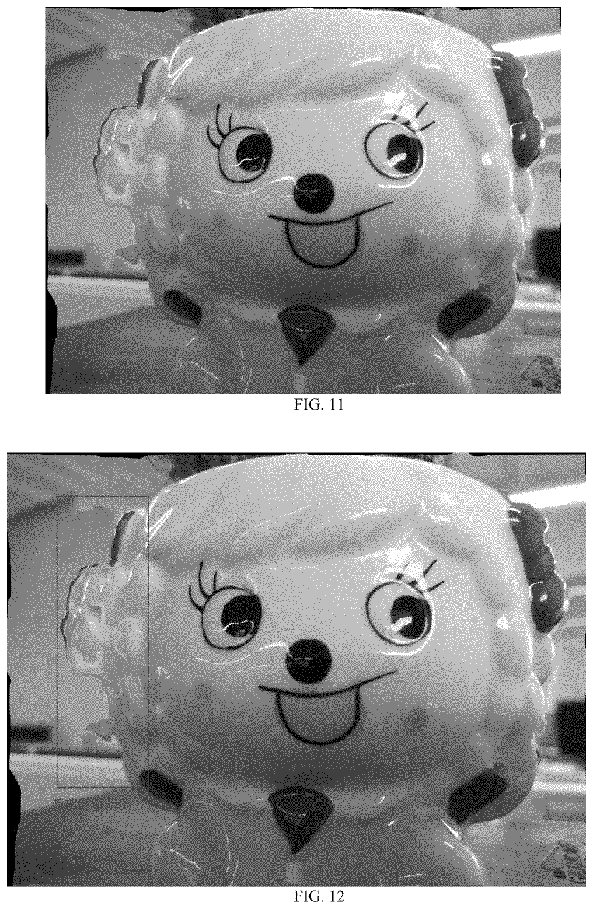

An embodiment of the present disclosure provides a method for detecting a blocked region, wherein the method may be implemented by an apparatus for detecting a blocked region, and the apparatus for detecting a blocked region may be integrated into an electronic device such as a mobile phone. As shown in FIG. 10, FIG. 10 is a flow chart of the method for detecting a blocked region according to an embodiment of the present disclosure. The method for detecting a blocked region comprises:

determining an erroneous registration point by using the method for detection of image registration stated above. In the method for detecting a blocked region, the particular contents of the determination of the erroneous registration points by using the method for detection of image registration may refer to the detailed description on the method for detection of image registration, and are not discussed here further.

Step 500: according to a region formed by the erroneous registration points, determining the blocked region.

The set of the erroneous registration points (the erroneous registration points may also be referred to as blocked points) is the blocked region. Accordingly, a blocked region can be detected, and, on the basis of that, the reference image can be registered with the image to be registered other than the blocked region (or two or more images other than the blocked region can be fused), which can obtain more fused area, and at the same time reduce the generation of artifact or chromatic aberration.

Regarding the artifact and the chromatic aberration after the image fusion, as shown in FIG. 11 as an example, wherein FIG. 11 is an example view after the registration of the reference image to the image to be registered, because the image to be registered has a blocked region at the left ear of the doll (the blocked region may be seen in FIG. 12 as an example), after the registration (after the image fusion) the left ear of the doll in the reference image has artifact, chromatic aberration and distortion. The part encircled by the rectangular block in FIG. 12 is the blocked region that is detected out (merely a schematic diagram; the actual blocked region is irregular).

Based on the detection of the blocked region, the fusion of double-photographed images may comprise firstly specifying the reference image, then excluding the blocked region in the image to be registered, and then performing registration and fusion. The fusion of multi-photographed images may comprise firstly specifying the reference image, then excluding the blocked regions of the other images of multi-photographed images one by one, and then performing registration and fusion. Accordingly, a fused image having less artifact and chromatic aberration can be obtained after the fusion.

In the process of the calculation of the homography matrix of two grids, the homography matrixes that are calculated out might be different because of the difference in the selected registration points. If the selected registration point is an erroneous registration point, that results in that the homography matrix that is calculated out has a large difference from the actual homography matrix, and the displacement difference that is calculated out accordingly is obviously larger (than a registration point correctly registered). Therefore, it cannot be directly determined that the registration point is an erroneous registration point only because the displacement difference of the registration point is greater than the preset threshold.

However, although the above-described registration point (the registration point correctly registered) might have a larger displacement difference for a single grid where it is located, the possibility that the displacement differences of the other grids where the registration point is located are also larger is very small. Therefore, a registration point all of whose displacement differences of the grids where it is located are greater than the preset threshold is determined as an erroneous registration point.

By reading through all of the registration points of the image to be registered, it can be determined one by one whether a registration point is an erroneous registration point, and in turn the blocked region can be determined according to the erroneous registration points.

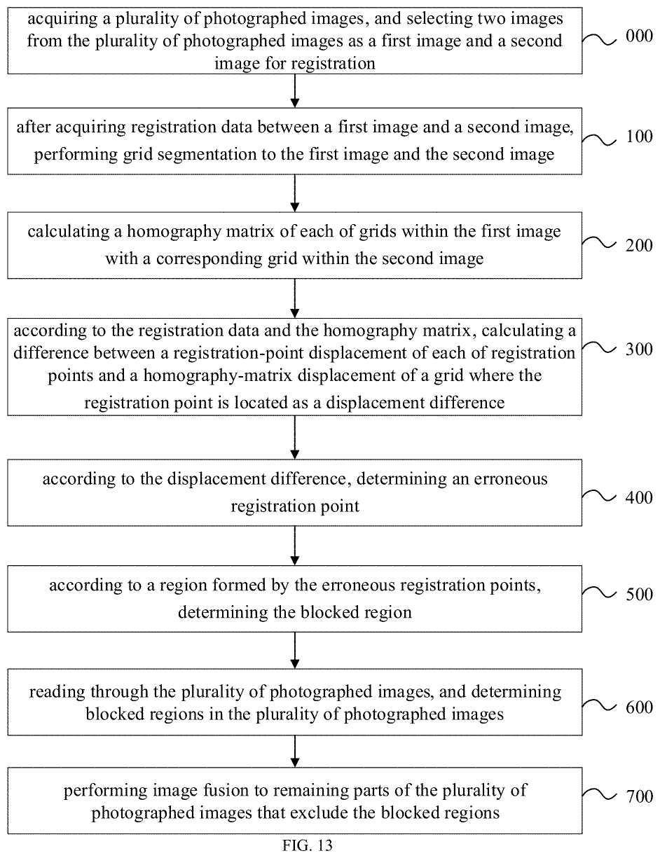

An embodiment of the present disclosure provides a method for fusing multi-photographed images, wherein the method may be implemented by a method for fusing multi-photographed images, and the apparatus for fusing multi-photographed images may be integrated into an electronic device such as a mobile phone. As shown in FIG. 13, FIG. 13 is a flow chart of the method for fusing multi-photographed images according to an embodiment of the present disclosure. The method for fusing multi-photographed images comprises:

Step 000: acquiring a plurality of photographed images, and selecting two images from the plurality of photographed images as a first image and a second image for registration.

The plurality of photographed images may be acquired simultaneously from a plurality of cameras, may also be image data received from a data interface, may also be acquired by cameras photographing from a plurality of positions, and may also be acquired in other manners.

In addition, the selecting of the two from the plurality of photographed images as the first image and the second image may be extracting two images randomly, and may also be specifying one image of the plurality of photographed images as the reference image, using all of the remaining images as the images to be registered, and extracting one from all of the images to be registered, and the reference image, as the first image and the second image.

By using the method for detecting a blocked region stated above, the blocked region is determined.

Step 600: reading through the plurality of photographed images, and determining blocked regions in the plurality of photographed images.

Step 700: performing image fusion to remaining parts of the plurality of photographed images that exclude the blocked regions.

In the method for fusing multi-photographed images, the particular contents of the determination of the blocked region by using the method for detecting a blocked region may refer to the detailed description on the method for detecting a blocked region, and are not discussed here further.

Accordingly, the blocked region can be detected by using the method for detecting a blocked region, and, on the basis of that, the reference image can be registered with the image to be registered other than the blocked region (or two or more images other than the blocked region can be fused), which can obtain more fused area, and at the same time reduce the generation of artifact or chromatic aberration.

Regarding the artifact and the chromatic aberration after the image fusion, as shown in FIG. 11 as an example, wherein FIG. 11 is an example view after the registration of the reference image to the image to be registered, because the image to be registered has a blocked region at the left ear of the doll (the blocked region may be seen in FIG. 12 as an example), after the registration (after the image fusion) the left ear of the doll in the reference image has artifact, chromatic aberration and distortion. The part encircled by the rectangular block in FIG. 12 is the blocked region that is detected out (merely a schematic diagram; the actual blocked region is irregular).

Based on the detection of the blocked region, the fusion of multi-photographed images may comprise firstly specifying the reference image, then excluding the blocked region in the image to be registered, and then performing registration and fusion. The fusion of multi-photographed images may comprise firstly specifying the reference image, then excluding the blocked regions of the other images of multi-photographed images one by one, and then performing registration and fusion. Accordingly, a fused image having less artifact and chromatic aberration can be obtained after the fusion, and no distortion appears.

Optionally, a quantity of the photographed images is two. That is a method of fusion of double-photographed images. Based on the detection of the blocked region, the blocked region in the image to be registered is excluded and then registration and fusion is performed. Accordingly, a fused image having less artifact and chromatic aberration can be obtained after the fusion.

An embodiment of the present disclosure provides an apparatus for detection of image registration, configured for implementing the method for detection of image registration described in the above contents according to the present disclosure, wherein the apparatus for detection of image registration will be described in detail below.

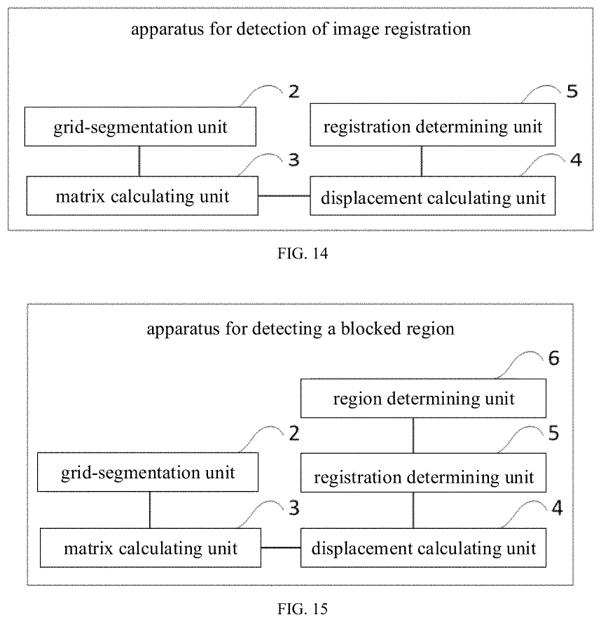

As shown in FIG. 14, FIG. 14 is a structural block diagram of the apparatus for detection of image registration according to an embodiment of the present disclosure. The apparatus for detection of image registration comprises:

a grid-segmentation unit 2 configured for, after acquiring registration data between a first image and a second image, performing grid segmentation to the first image and the second image, wherein the registration data include at least a registration-point coordinate and a registration-point displacement;

a matrix calculating unit 3 configured for calculating a homography matrix of each of grids within the first image with a corresponding grid within the second image;

a displacement calculating unit 4 configured for, according to the registration data and the homography matrix, calculating a difference between a registration-point displacement of each of registration points and a homography-matrix displacement of a grid where the registration point is located as a displacement difference; and

a registration determining unit 5 configured for, according to the displacement difference, determining an erroneous registration point, wherein a registration point whose displacement difference from the grid where the registration point is located satisfies a predetermined condition is determined as an erroneous registration point.

Accordingly, by detecting the registration points of the image that has been registered, the erroneous registration points therein can be determined, which can, based on the original image registration, further increase the accuracy of the registration.

Optionally, in the grid-segmentation unit 2, the grid segmentation performed to the first image and the second image is overlapping-grid segmentation.

Optionally, in the grid-segmentation unit 2, in the overlapping-grid segmentation performed to the first image and the second image, an overlapping area between neighboring grids in the first image and the second image is at least ½ of an area of a single grid.

Optionally, in the grid-segmentation unit 2, the registration between the first image and the second image is dense registration.

Optionally, the displacement calculating unit 4 is further configured for, according to the registration data between the first image and the second image, determining a reference image in the registration; acquiring a homography matrix of grids within an image to be registered and registration-point coordinates and registration-point displacements of registration points contained in the grids, wherein the image to be registered refers to other image than the reference image from the first image and the second image; according to the homography matrix of the grids within the image to be registered and the registration-point coordinates of the registration points contained in the grids, calculating the homography-matrix displacement of the grid where the registration point is located; and calculating a difference between a registration-point displacement of the registration point and the homography-matrix displacement of the grid where the registration point is located as the displacement difference.

Optionally, the registration determining unit 5 is further configured for acquiring displacement differences between a same registration point and different grids where the registration point is located, wherein the same registration point has at least two grids where it is located; determining whether all of the displacement differences between the registration point and the grids where the registration point is located are greater than a preset threshold; and if all of the displacement differences are greater than the preset threshold, determining that the registration point is an erroneous registration point.

Optionally, the matrix calculating unit 3 is further configured for acquiring the registration data between grids within the first image and corresponding grids within the second image; screening the registration data; and according to the registration data obtained after the screening, calculating the homography matrix of the grids within the first image with the corresponding grids within the second image.

Optionally, the matrix calculating unit 3 is further configured for, according to the registration-point coordinate and the registration-point displacement in the registration data, determining a subordination relation of the registration-point coordinate with the grids within the first image and the corresponding grids within the second image, wherein the subordination relation refers to whether the registration point is located in the grids within the first image or located in the grids within the second image; and screening the registration points according to the subordination relation, wherein two registration points that are registered in the maintained registration data are individually located in the grids within the first image and located in the corresponding grids within the second image.

An embodiment of the present disclosure provides an apparatus for detecting a blocked region, configured for implementing the method for detecting a blocked region described in the above contents according to the present disclosure, wherein the apparatus for detecting a blocked region will be described in detail below.

As shown in FIG. 15, FIG. 15 is a structural block diagram of the apparatus for detecting a blocked region according to an embodiment of the present disclosure. The apparatus for detecting a blocked region comprises:

the apparatus for detection of image registration configured for determining erroneous registration points; and

a region determining unit 6 configured for, according to a region formed by the erroneous registration points, determining the blocked region.

Accordingly, a blocked region can be detected, and, on the basis of that, the reference image can be registered with the image to be registered other than the blocked region (or two or more images other than the blocked region can be fused), which can obtain more fused area, and at the same time reduce the generation of artifact or chromatic aberration.

In the apparatus for detecting a blocked region, the particular contents of the determination of the erroneous registration points by the apparatus for detection of image registration may refer to the detailed description on the apparatus for detection of image registration, and are not discussed here further.

An embodiment of the present disclosure provides an apparatus for fusing multi-photographed images, configured for implementing the method for fusing multi-photographed images described in the above contents according to the present disclosure, wherein the apparatus for fusing multi-photographed images will be described in detail below.

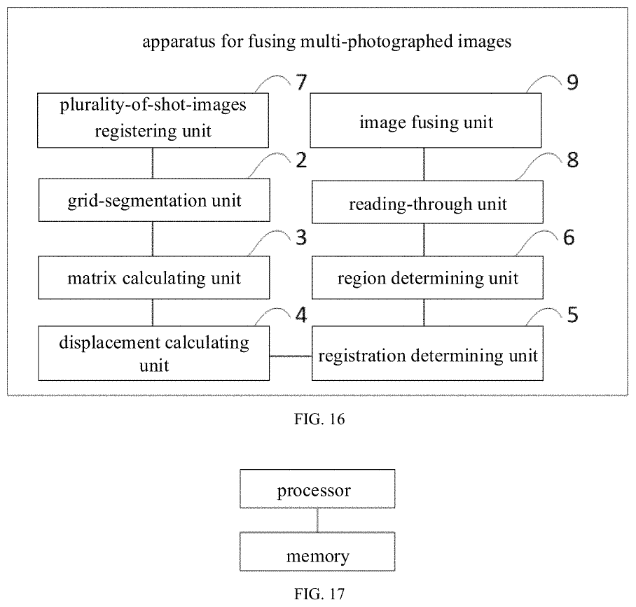

As shown in FIG. 16, FIG. 16 is a structural block diagram of the apparatus for fusing multi-photographed images according to an embodiment of the present disclosure. The apparatus for fusing multi-photographed images comprises:

a plurality-of-shot-images registering unit 7 configured for acquiring a plurality of photographed images, and selecting two images from the plurality of photographed images as a first image and a second image for registration;

the apparatus for detecting a blocked region configured for determining the blocked region;

a reading-through unit 8 configured for reading through the plurality of photographed images, and determining blocked regions in the plurality of photographed images; and

an image fusing unit 9 configured for performing image fusion to remaining parts of the plurality of photographed images that exclude the blocked regions.

Based on the detection of the blocked region, the fusion of multi-photographed images may comprise firstly specifying the reference image, then excluding the blocked region in the image to be registered, and then performing registration and fusion. The fusion of multi-photographed images may comprise firstly specifying the reference image, then excluding the blocked regions of the other images of multi-photographed images one by one, and then performing registration and fusion. Accordingly, a fused image having less artifact and chromatic aberration can be obtained after the fusion, and no distortion appears.

It should be noted that the above-described device embodiments are merely illustrative. For example, the division between the units is merely a division in the logic functions, and in the actual implementation there may be another mode of division. As another example, multiple units or components may be combined or may be integrated into another system, or some of the features may be omitted, or not implemented. Additionally, the coupling or direct coupling or communicative connection between the illustrated or discussed components may be via communication interfaces or the indirect coupling or communicative connection between the devices or units, and may be electric, mechanical or in other forms.

The internal functions and the structures of the apparatus for detection of image registration, the apparatus for detecting a blocked region and the apparatus for fusing multi-photographed images are described above. As shown in FIG. 17, in practice, the apparatus for detection of image registration, the apparatus for detecting a blocked region and the apparatus for fusing multi-photographed images may be implemented as an electronic device, comprising: a processor and a memory, wherein the memory stores a controlling program, and the controlling program, when executed by the processor, implements the method for detection of image registration stated above, or implements the method for detecting a blocked region stated above, or implements the method for fusing multi-photographed images stated above.

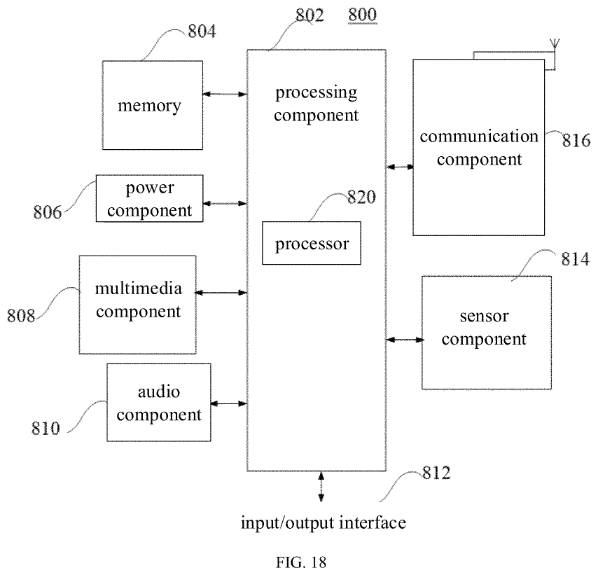

FIG. 18 is a block diagram of another electronic device according to an embodiment of the present disclosure. For example, the electronic device 800 may be a mobile phone, a computer, a digital broadcasting terminal, a message transceiver, a game console, a tablet device, a medical device, a body building device, a personal digital assistant and so on.

As shown in FIG. 18, the electronic device 800 may comprise the following one or more components: a processing component 802, a memory 804, a power component 806, a multimedia component 808, an audio component 810, an input/output (I/O) interface 812, a sensor component 814, and a communication component 816.

The processing component 802 generally controls the overall operations of the electronic device 800, such as the operations associated with displaying, telephone call, data communication, camera operation and recording operation. The processing component 802 may comprise one or more processors 820 for executing instructions, to complete all or some of the steps of the above methods. Furthermore, the processing component 802 may comprise one or more modules for the interaction between the processing component 802 and the other components. For example, the processing component 802 may comprise a multimedia module for the interaction between the multimedia component 808 and the processing component 802.

The memory 804 is configured to store various types of data to support the operations in the device 800. Examples of those data include instructions of any application software or methods operating in the electronic device 800, contact-person data, telephone-directory data, messages, pictures, videos and so on. The memory 804 may be implemented by using any type of volatile or non-volatile storage devices or combinations thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disc.

The power component 806 provides electric power to the components of the electronic device 800. The power component 806 may comprise a power-supply managing system, one or more power supplies, and other components associated with the generation, management and distribution of electric power for the electronic device 800.

The multimedia component 808 comprises a screen providing an output interface between the electronic device 800 and the user. In some embodiments, the screen may comprise a liquid-crystal display (LCD) and a touch panel (TP). If the screen comprises a touch panel, the screen may be implemented as a touch screen, to receive an input signal from the user. The touch panel comprises one or more touch sensors to sense touches, slides and hand gestures on the touch panel. The touch sensors cannot only sense the boundary of the touching or sliding actions, but can also detect the duration and the pressure related to the touching or sliding operations. In some embodiments, the multimedia component 808 comprises a front-facing camera and/or rear-facing camera. When the device 800 is in an operating mode, such as a photographing mode or a videoing mode, the front-facing camera and/or rear-facing camera may receive external multimedia data. Each of the front-facing camera and the rear-facing camera may be a fixed optical lens system or has a focal length and a capacity of optical zoom.

The audio component 810 is configured to output and/or input an audio signal. For example, the audio component 810 comprises a microphone (MIC). When the electronic device 800 is in an operating mode, such as a calling mode, a recording mode and a voice-recognition mode, the microphone is configured to receive an external audio signal. The received audio signal may be further stored in the memory 804 or emitted by the communication component 816. In some embodiments, the audio component 810 further comprises a loudspeaker for outputting an audio signal.

The I/O interface 812 provides an interface between the processing component 802 and a peripheral interface module. The peripheral interface module may be a keyboard, a click wheel, a button and so on. The button may include but is not limited to a homepage button, a volume button, a starting button and a locking button.

The sensor component 814 comprises one or more sensors for providing state assessment of aspects of the electronic device 800. For example, the sensor component 814 may detect the turning-on/turning-off states of the device 800 and the relative positioning of the components; for example, the components are the display and the keypad of the electronic device 800. The sensor component 814 may also detect the position change of the electronic device 800 or one of the components of the electronic device 800, the existence or inexistence of contact between the user and the electronic device 800, the direction or acceleration/deceleration of the electronic device 800, and the temperature change of the electronic device 800. The sensor component 814 may comprise a proximity sensor configured to detect the existence of an adjacent object when there is no physical contact. The sensor component 814 may also comprise an optical sensor, such as a CMOS or CCD image sensor, configured to be used in imaging applications. In some embodiments, the sensor component 814 may also comprise an acceleration sensor, a gyroscope sensor, a magnetic sensor, a pressure sensor or a temperature sensor.

The communication component 816 is configured for the communication between the electronic device 800 and other devices in a wired or wireless mode. The electronic device 800 may be accessed to a wireless network based on a communication standard, such as WiFi, 2G or 3G, or a combination thereof. In an illustrative embodiment, the communication component 816 receives via a broadcast channel a broadcast signal or broadcast-relevant information from an external broadcast managing system. In an illustrative embodiment, the communication component 816 further comprises a near-field communication (NFC) module, to facilitate short-range communication. For example, the NFC module may be implemented based on the radio frequency identification (RFID) technique, the infra-red data association (IrDA) technique, the ultra wide band (UWB) technique, the Bluetooth (BT) technique and other techniques.

In an illustrative embodiment, the electronic device 800 may be implemented by using one or more Application Specific Integrated Circuits (ASIC), Digital Signal Processors (DSP), Digital Signal Processing Devices (DSPD), Programmable Logic Devices (PLD), Field-Programmable Gate Arrays (FPGA), controllers, microcontrollers, microprocessors or other electronic elements, to implement the above methods.

The embodiments of the present application have at least the following advantageous effects:

by detecting the registration points of the image that has been registered, the erroneous registration points therein can be determined, which can, based on the original image registration, further increase the accuracy of the registration.

An embodiment of the present disclosure provides a computer-readable storage medium, storing an instruction, wherein the instruction, when loaded and executed by a processor, implements the method for detection of image registration stated above, or implements the method for detecting a blocked region stated above.

The computer-readable storage medium according to the embodiment of the present application includes but is not limited to any type of disks (including a floppy disk, a hard disk, an optical disk, a CD-ROM and a magneto-optical disk), a ROM (Read-Only Memory), a RAM (Random Access Memory), an EPROM (Erasable Programmable Read-Only Memory), an EEPROM (Electrically Erasable Programmable Read-Only Memory), a flash memory, a magnetic card or a light-ray card. In other words, the readable storage medium includes any media that a device (for example, a computer) uses to store or transmit information in a readable form.

The embodiments of the present application have at least the following advantageous effects:

By detecting the registration points of the image that has been registered, the erroneous registration points therein can be determined, which can, based on the original image registration, further increase the accuracy of the registration.

The technical solutions of the embodiments of the present disclosure substantially, or the part that makes contribution over the prior art, or the whole or part of the technical solutions, may be embodied in the form of a software product. The computer software product is stored in a storage medium, and contains a plurality of instructions configured to enable a computer device (which may be a personal computer, a server, a network device and so on) or a processor to perform all or some of the steps of the methods according to the embodiments of the present disclosure. Moreover, the storage medium includes various media that can store a program code, such as a USB flash disk, a mobile hard disk drive, a ROM, a RAM, a diskette and an optical disc.

A person skilled in the art can understand that the steps, measures and solutions in the various operations, methods and processes that have been discussed in the present application may be substituted, modified, combined or deleted. Further, the other steps, measures and solutions in the various operations, methods and processes that have been discussed in the present application may be substituted, modified, rearranged, disassembled, combined or deleted. Further, the steps, measures and solutions in the various operations, methods and processes disclosed in the present application in the prior art may be substituted, modified, rearranged, disassembled, combined or deleted.

The above-described are merely some of the embodiments of the present application. It should be noted that a person skilled in the art may make various improvements without departing from the principle of the present application, wherein those improvements should be considered as falling within the protection scope of the present application.

1. A method for detection of image registration, wherein the method comprises:
after acquiring registration data between a first image and a second image, performing grid segmentation to the first image and the second image, wherein the registration data include at least a registration-point coordinate and a registration-point displacement;
calculating a homography matrix of each of grids within the first image with a corresponding grid within the second image;
according to the registration data and the homography matrix, calculating a difference between a registration-point displacement of each of registration points and a homography-matrix displacement of a grid where the registration point is located as a displacement difference; and
according to the displacement difference, determining an erroneous registration point, wherein a registration point whose displacement difference from the grid where the registration point is located satisfies a predetermined condition is determined as an erroneous registration point.

2. The method for detection of image registration according to claim 1, wherein in the step of after acquiring the registration data between the first image and the second image, performing grid segmentation to the first image and the second image, the grid segmentation performed to the first image and the second image is overlapping-grid segmentation.

3. The method for detection of image registration according to claim 2, wherein when performing overlapping-grid segmentation to the first image and the second image, an overlapping area between neighboring grids in the first image and the second image is at least ½ of an area of a single grid.

4. The method for detection of image registration according to claim 1, wherein in the step of after acquiring registration data between a first image and a second image, performing grid segmentation to the first image and the second image, the registration between the first image and the second image is dense registration.

5. The method for detection of image registration according to claim 1, wherein the step of, according to the registration data and the homography matrix, calculating the difference between the registration-point displacement of each of the registration points and the homography-matrix displacement of the grid where the registration point is located as the displacement difference comprises:
according to the registration data between the first image and the second image, determining a reference image in the registration;
acquiring a homography matrix of grids within an image to be registered and registration-point coordinates and registration-point displacements of registration points contained in the grids, wherein the image to be registered refers to other image than the reference image from the first image and the second image;
according to the homography matrix of the grids within the image to be registered and the registration-point coordinates of the registration points contained in the grids, calculating the homography-matrix displacement of the grid where the registration point is located; and
calculating a difference between the registration-point displacement of the registration point and the homography-matrix displacement of the grid where the registration point is located as the displacement difference.

6. The method for detection of image registration according to claim 1, wherein the step of, according to the displacement difference, determining the erroneous registration point comprises:
acquiring displacement differences between a registration point and different grids where the registration point is located, wherein the registration point has at least two grids where the registration point is located;
determining whether all of the displacement differences between the registration point and the different grids where the registration point is located are greater than a preset threshold; and
if all of the displacement differences are greater than the preset threshold, determining that the registration point is an erroneous registration point.

7. The method for detection of image registration according to claim 1, wherein the step of calculating the homography matrix of each of the grids within the first image with the corresponding grid within the second image comprises:
acquiring the registration data between the grids within the first image and the corresponding grids within the second image;
screening the registration data; and
according to registration data obtained after the screening, calculating the homography matrix of the grids within the first image with the corresponding grids within the second image.

8. The method for detection of image registration according to claim 7, wherein the step of screening the registration data comprises:
according to the registration-point coordinate and the registration-point displacement in the registration data, determining a subordination relation of the registration-point coordinate with the grids within the first image and the corresponding grids within the second image, wherein the subordination relation refers to whether the registration point is located in the grids within the first image or located in the grids within the second image; and
screening the registration points according to the subordination relation, wherein two registration points that are registered in the maintained registration data are individually located in the grids within the first image and located in the corresponding grids within the second image.

9. A method for detecting a blocked region, wherein the method comprises:
determining erroneous registration points by using the method for detection of image registration according to claim 1; and
according to a region formed by the erroneous registration points, determining the blocked region.

10. A method for fusing multi-photographed images, wherein the method comprises:
acquiring a plurality of photographed images, and selecting two images from the plurality of photographed images as a first image and a second image for registration;
determining a blocked region by using the method for detecting the blocked region according to claim 9;
reading through the plurality of photographed images, and determining blocked regions in the plurality of photographed images; and
performing image fusion to remaining parts of the plurality of photographed images that exclude the blocked regions.

11. The method for fusing multi-photographed images according to claim 10, wherein a quantity of the photographed images is two.

12-14. (canceled)

15. An electronic device, comprising a processor and a memory, wherein the memory stores a controlling program, and the controlling program, when executed by the processor, implements the method for detection of image registration according to claim 1.

16. A nonvolatile computer-readable storage medium, storing an instruction, wherein the instruction, when loaded and executed by a processor, implements the method for detection of image registration according to claim 1.

17. An electronic device, comprising a processor and a memory, wherein the memory stores a controlling program, and the controlling program, when executed by the processor, implements the method for detecting a blocked region according to claim 9.

18. An electronic device, comprising a processor and a memory, wherein the memory stores a controlling program, and the controlling program, when executed by the processor, implements the method for fusing multi-photographed images according to claim 10.

19. A nonvolatile computer-readable storage medium, storing an instruction, wherein the instruction, when loaded and executed by a processor, implements the method for detecting a blocked region according to claim 9.

20. A nonvolatile computer-readable storage medium, storing an instruction, wherein the instruction, when loaded and executed by a processor, implements the method for fusing multi-photographed images according to claim 10.

21. The method for detection of image registration according to claim 2, wherein in the step of after acquiring registration data between a first image and a second image, performing grid segmentation to the first image and the second image, the registration between the first image and the second image is dense registration.

22. The method for detection of image registration according to claim 5, wherein the step of, according to the displacement difference, determining the erroneous registration point comprises:
acquiring displacement differences between a registration point and different grids where the registration point is located, wherein the registration point has at least two grids where the registration point is located;
determining whether all of the displacement differences between the registration point and the different grids where the registration point is located are greater than a preset threshold; and
if all of the displacement differences are greater than the preset threshold, determining that the registration point is an erroneous registration point.

23. The method for detection of image registration according to claim 5, wherein the step of calculating the homography matrix of each of the grids within the first image with the corresponding grid within the second image comprises:
acquiring the registration data between the grids within the first image and the corresponding grids within the second image;
screening the registration data; and
according to registration data obtained after the screening, calculating the homography matrix of the grids within the first image with the corresponding grids within the second image.
